(19) United States
(12) Patent Application Publication
(10) Pub. No.: US 2025/0353008 A1
(43) Pub. Date: Nov. 20, 2025

(54) AN ANALYZER AND A SENSOR DISC ASSEMBLY FOR THE ANALYZER

(71) Applicant: Summa Finland Oy, Oulu (FI)

(72) Inventors: Paavo Pietola, Helsinki (FI); Marko Mäkinen, Oulu (FI); Juuso Nissilä, Oulu (FI); Saija Taponen, Oulu (FI)

(73) Assignee: Summa Finland Oy, Oulu (FI)

(21) Appl. No.: 19/208,054

(22) Filed: May 14, 2025

(30) Foreign Application Priority Data
May 15, 2024 (FI) 20245610

(51) Int. Cl. B01L 3/00

(52) U.S. Cl. CPC B01L 3/502753; B01L 3/502715; B01L 3/50273; B01L 2300/0681; B01L 2300/0803; B01L 2400/0478

(57) ABSTRACT

A sensor disc assembly (SDA). SDA includes cavity plate (CP) and sensor layer (SL). CP includes sample cavity for receiving sample collecting part containing sample fluid; first cavity fluidically connected (FC) to sample cavity by first channel; overflow cavity FC to first cavity by second channel; second cavity containing antibodies and FC to first cavity by third channel; expansion cavity FC to second cavity by fifth channel; third cavity for accommodating antibodies-mixed sample fluid and connected to second cavity by fourth channel; exit aperture FC to third cavity by sixth channel; and first set of cavities containing reagents or enzyme substrates and FC to exit aperture by first set of channels. Sensor layer comprises volume; and sensor to measure properties of fluids in volume. Disclosed also is analyzer including slot for receiving aforementioned SDA; set of actuators; electrical interface to sensor; and interface to provide analysis results.

### TECHNICAL FIELD

The present disclosure relates to sensor disc assembly. Moreover, the present disclosure relates to analyzer.

### BACKGROUND

Generally, appropriate collection of sample fluids from subjects and their analysis for various applications such as molecular epidemiology, clinical trials and basic research studies, is dependent on corresponding collection and analysis platforms.

Conventionally, low or high amounts of the sample fluids may be collected and analyzed by using separate systems for collection and analysis, or using a single multifaceted system for both collection and analysis. In this regard, in both cases, a specific quantity of reagents for analyzing the collected samples are used in the aforementioned conventional systems. However, often the ratio of amounts of the sample fluid and the reagents is either too high or too low, resulting in inaccurate analysis. Moreover, the involvement of separate systems for separate functions makes the whole process complicated as well as prone to a potential contamination of the sample during the transit. Also, involvement of the single multifaceted system may be associated with potential leakage from a sample collection or a analysis unit thereof, or inaccurate sample fluid processing before analyzing.

Therefore, in light of the foregoing discussion, there exists a need to overcome the aforementioned drawbacks.

### SUMMARY

The aim of the present disclosure is to provide a sensor disc assembly and an analyzer to analyze samples in a sequential manner by moving the samples via different phases and mixing with controlled amounts of antibodies, reagents and/or enzymes for analysis. The aim of the present disclosure is achieved by sensor disc assembly and an analyzer for analyzing a sample, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 is a schematic illustration of an exploded view of a sensor disc assembly, in accordance with an embodiment of the present disclosure;

FIG. 2 is a schematic illustration of a sensor disc assembly in use with a sample collecting part, in accordance with an embodiment of the present disclosure;

FIG. 3 is a schematic illustration of a cavity plate, in accordance with an embodiment of the present disclosure;

FIGS. 4A and 4B are schematic illustrations of an interaction between the cavity plate and the set of actuators, when in use, in accordance with an embodiment of the present disclosure;

FIG. 4C is a schematic illustration of the expansion cavity of the cavity plate, in accordance with an embodiment of the present disclosure;

FIG. 5A is a schematic illustration of an analyzer, in accordance with an embodiment of the present disclosure;

FIG. 5B is a schematic illustration of an exploded view of the analyzer, in accordance with an embodiment of the present disclosure;

FIG. 6 is a schematic illustration of an implementation of the sensor disc assembly and the analyzer, in accordance with an embodiment of the present disclosure;

FIG. 7 is a schematic illustration of a timeline of actuating various actuators from amongst a set of actuators of the analyzer, in accordance with an embodiment of the present disclosure;

FIG. 8 is a schematic illustration of a sensor disc assembly according to one embodiment; and

FIG. 9 is schematic illustration of a sensor disc assembly seen from top and perspective view.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, the present disclosure provides a sensor disc assembly comprising:
a cavity plate comprising:
   a sample cavity for receiving a sample collecting part containing a sample fluid;
   a first cavity fluidically connected to the sample cavity by a first channel;
   an overflow cavity fluidically connected to the first cavity by a second channel;
   a second cavity containing antibodies and fluidically connected to the first cavity by a third channel;
   an expansion cavity fluidically connected to the second cavity by a fifth channel;
   a third cavity for accommodating the sample fluid mixed with antibodies and connected to the second cavity by a fourth channel;
   an exit aperture fluidically connected to the third cavity by a sixth channel; and
   a first set of cavities containing reagents or enzyme substrates and fluidically connected to the exit aperture by respective first set of channels; and
a sensor layer comprising
   a volume, wherein the fluids are provided to the volume from the exit aperture; and
   a sensor arranged to measure properties of fluids in the volume, when in use.

The aforementioned sensor disc assembly is designed to ensure that an adequate amount of the sample fluid is collected and processed to facilitate an accurate and precise sensing and analysis of the sample fluid, when required. In this regard, the sensor disc assembly aims to be more reliable and efficient for collecting the sample fluid, i.e., a biological material such as saliva, sweat, blood, snot or urine, from a subject. The sample might be collected by means of a sample collection stick. The sensor disc assembly employs a good mixture of antibodies, reagents and enzymes that can be mixed with the collected sample fluid, and the mixture is subsequently provided to the sensor, in precise and controlled manner. Moreover, the quantity of the antibodies, reagents and enzymes is controlled based on the amount of sample fluid and vice versa, as the sensor disc assembly is configured to determine the quantity of sample fluid that is eventually used for analysis.

In a second aspect, the present disclosure provides an analyzer comprising:
a slot for receiving a sensor disc assembly, the sensor disc assembly having a cavity plate and a sensor layer;
a set of actuators arranged on the analyzer, when in use, to exert force to cavities of the cavity plate of the sensor disc assembly in a sequential manner to move fluids between the cavities by channels fluidically connecting the cavities;
an electrical interface to a sensor of the sensor layer; and
an interface to provide analysis results related to the sensor reading.

The aforementioned analyzer is equipped with actuators and interfaces necessary for fluid manipulation and data acquisition. Moreover, the analyzer analyzes samples in a sequential manner by moving the samples via different phases and mixing with controlled amounts of antibodies, reagents and/or enzymes for analysis.

It may be appreciated that the disclosed sensor disc assembly and the analyzer is easy to use and maybe used in medical testing applications, making hormonal tests, health support areas, and so forth.

Throughout the present disclosure, the term “sensor disc assembly” refers to a comprehensive structure designed for precise fluid handling and analysis. The sensor disc assembly comprises the cavity plate housing various cavities and channels, meticulously arranged to facilitate efficient sample collection, movement and manipulation of fluids during the analysis process, ensuring accurate and precise analysis.

In this regard, the sensor disc assembly is implemented as a casing comprising a base part and a lid part coupled to the base part. Herein, the term “base part” refers to a supporting part (or component) of the sensor disc assembly that is configured to contain various sub-components of the sensor disc assembly that are required for the collection of the sample fluid and the subsequent sensing of data from the collected sample fluid. Herein, the term “lid part” refers to a cover part (or component) of the sensor disc assembly that is configured to temporarily provide access to or to close or seal a top portion of the base part according to the application of the sensor disc assembly. It will be appreciated that the base part and the lid part may in a first configuration (i.e., open), that provides an access to an inside of the sensor disc assembly; and in a second configuration (i.e., closed), that prevents an access to the inside of the sensor disc assembly. In this regard, the lid part is configured to completely close or seal the base part when the sensor disc assembly is either not in use or when the base part accommodates the sample fluid therein, thereby preventing the sample fluid from being contaminated or leaking from the sensor disc assembly.

Herein, the base part and the lid part are complimentary to each other. Optionally, the sensor disc assembly may be in the form of a disc, a sphere or any other polygonal shape when the base part and the lid part are arranged in the second configuration. In this regard, the base part is a planar structure having an inner side and an outer side that is opposite the inner side, where a circumferential boundary wall of a predefined height is present around the inner side of the base part. Moreover, a circumferential boundary wall of the lid part couples with the circumferential boundary wall of base part to close or seal the sensor disc assembly.

Optionally, the lid part is at least partially coupled to the base part with a hinge. Herein, the at least partial coupling of the lid part to the base part with the hinge enables the lid part to close or seal the base part in a pivoting mechanism. Additionally, beneficially, the lid is designed to be easily opened and closed, facilitating convenient loading and unloading of sample fluid, and enhancing the user-friendliness of the sensor disc assembly. Additionally, beneficially, the technical effect obtained by the coupling of the lid part with the base part is that the pressure generation is more cost-effective in said design.

The base part comprises the cavity plate comprising a plurality of cavities, namely the sample, first, overflow, second, third, and first set of cavities, and the expansion cavity (or expansion chamber) fluidically connecting an inner side of the cavity plate and an outer side of the cavity plate, wherein the outer side is opposite to the inner side of the cavity plate, the cavity plate is configured to receive the sample fluid on the inner side of the cavity plate, specifically in the sample plate. As an example, the sample fluid can be provided directly to the inner side of the cavity (such as splitting, urinating, etc.). Alternatively, the inner side of the cavity can be configured to accommodate the sample collection part of a sample stick. The sample stick can be constructed as porous sample collection part arranged at the tip of an elongated stick. Herein, the term “cavity plate” refers to a plate (flat or planar structure) arranged on a top surface of the inner side of the base part for receiving the sample fluid inside the base part. Herein, the term “cavity” as used in the sample cavity, the first cavity, the overflow cavity, the second cavity, the third cavity, and the first set of cavities, refers to a depression arranged at least partly in the cavity plate. Moreover, the inner side of the cavity is fluidically connected to the outer side of the cavity via the plurality of channels, such as the first-sixth channels, and the first set of channels, such as seventh-ninth channels, for ensuring that the sample fluid is able to flow from the inner side of the sample cavity to the outer side of the cavity via various other mentioned cavities and channels in path of the inner side and outer side of the cavity plate. Optionally the fluidical connection via the plurality of channels may resemble the working of a sieve. It may be appreciated that the plurality of channels may be arranged so as to form a microfluidic plate beneath the inner side of the cavity plate. Herein, the term “microfluidic plate” refers to a plate, fluidically connected to a second side of the sample cavity, via microfluidic channels that are configured to channelize the flow of the sample fluid to from one region (i.e., the sample cavity) to another region (i.e., the sensor). The microfluidic plate is configured to channelize a flow of the at least a part of the sample fluid received via the plurality of channels towards the sensor coupled to the outer side of the cavity plate.

Herein, the term “sensor” refers to a device configured to sense data related to a certain physical, electrical, biological, or chemical property. In this regard, the sensor has at least one opening and at least a part of the sample fluid that is channelized to the sensor is received via said at least one opening. It will be appreciated that the sensor is activated when the sample fluid from the microfluidic plate contacts or penetrates into the sensor. Further, there may be an arrangement of fluidic channels dedicated to deliver reagents or chemicals helping to perform a chemical reaction or washing in the sensor. In accordance with embodiments, the chemicals may be stored in breakable or squeezable form within the sensor disc assembly. Alternatively, chemicals may be delivered from outside of the sensor disc assembly.

The cavity plate comprises the sample cavity for receiving the sample collecting part containing the sample fluid. The sample cavity serves as an entry point for the sample fluid, which is collected from an external source. The sample cavity acts as a reservoir for the initial sample fluid volume. Herein, the cavity plate is arranged on the base part of the sensor disc assembly, such that the sample cavity is exposed from the top portion of the base part. Optionally, the sample cavity may be arranged in the center of the cavity plate. Moreover, the sample cavity is implemented as a well of a predefined volume and a cross-section corresponding to a cross-section of the sample collection part. Optionally, the sample cavity may be circular, oval, elliptical, triangular, square, hexagonal, or any other polygonal shape. Optionally, an inner side of the lid part comprises a protrusion complementary to the cross-section of the sample cavity. In this regard, when in use, i.e., in the second configuration, the lid part covers the sample cavity and prevents the sample fluid from potential contamination or leakage from the sensor disc assembly.

The sample fluid is delivered using the sample collection part of the sample stick (or swab stick) which is accommodated in the sample cavity, when in use. Herein, the term “sample stick” refers to an elongate tool or instrument for collecting the sample fluid from a person (subject or patient). Specifically, the sample collection part, arranged at a proximal end of the sample stick, is used to collect and temporarily store the sample fluid. Therefore, only the sample collection part of the sample stick is accommodated inside the sensor disc assembly such that the sample collection part snuggly fits into the sample cavity of the cavity plate to transfer at least a part of the sample fluid to the sample cavity, while the rest of the sample stick protrudes out of the sensor disc assembly. A benefit of delivering the sample fluid using the sample collection part of the sample stick is to avoid contamination of the sample fluid as a person taking the sample fluid holds the sample stick remotely from the sample collection part of the sample stick.

Optionally, the sample collection part of the sample stick is made of a soft, porous tissue. Notably, the soft, porous tissue allows greater absorption of the sample fluid and subsequently allow at least a part of the sample fluid to be extracted therefrom when the sample collection part is subjected to compressed under influence of an external pressure. Moreover, the soft, porous tissue may be biocompatible, thus allowing the sample collection part to be safe for being contacted with sensitive parts, such as the mouth, the nose, the ear, and so forth, of the subject's body for collecting the sample fluid.

Alternatively, the sample can be delivered via a hose (or flexible pipe) having one end in mouth of a user and other end in sample feeding inlet of the cavity plate. In this embodiment the sample cavity comprises a blister arranged in top of the cavity. The blister is used to pump sample directly from the mouth of the user thus the sample cavity receives the sample fluid directly (via the hose and the sample feeding inlet). I.e. the sample can be delivered using a sample collection part or it can be delivered as a sample fluid to the sample cavity.

Moreover, the cavity plate comprises a first cavity fluidically connected to the sample cavity by a first channel, and an overflow cavity fluidically connected to the first cavity by a second channel. The term “first cavity” as used herein refers to the first chamber that receives the sample fluid from the sample cavity via the first channel, allowing the sample fluid to flow seamlessly into this first cavity. In this regard, optionally, the sample cavity may be raised compared to the first cavity. Herein, the first channel may be a fluidic channel configured to transfer at least partially a volume of the sample fluid from the sample cavity to the first cavity. The fluidic channels are preferably “milli” fluidic channels, indicating that the fluid can be forced thru the channel when a force is applied, but the channel is not so narrow that the fluid would move capillarity. In an alternative embodiment the fluidic channels can be microfluid channels. It may be appreciated that a volume of the first cavity is smaller than a volume of the sample cavity. Therefore, an excess volume of the sample fluid from the first cavity flows into the overflow cavity fluidically connected to the first cavity by the second channel, such that the excess volume of the sample fluid from the first cavity is prevented from leaking therefrom and spreading out on the cavity plate or the base part of the sensor disc assembly. In one embodiment the fluidic connection between the first cavity is by the second channel and other channels. In deed fluidic connection can be arranged in some embodiments via more than one channel and also via one or more cavities depending on how the pistons controlling to flows in the sensor disc are positioned (open, closed). Moreover, the overflow cavity ensures a controlled overflow and prevents backflow of the sample fluid, maintaining the integrity of the analysis process. In some embodiment the overflow cavity might receive overflow from a volume of a sensor layer as well. The overflow cavity might be arranged as a channel having “open” bottom facing porous membrane. It may be appreciated that the second channel may also be a fluidic channel, similar to the first channel, with a cross-sectional diameter similar to the first channel or wider than the first channel. Beneficially, the wider cross-sectional diameter of the second channel allows for faster removal of the excess volume of the sample fluid from the first cavity thereby preventing leakage therefrom.

Furthermore, the cavity plate comprises the second cavity containing antibodies and fluidically connected to the first cavity by the third channel, the third cavity for accommodating the sample fluid mixed with antibodies and connected to the second cavity by the fourth channel; and an expansion cavity fluidically connected to the second cavity by a fifth channel. The term “second cavity” as used herein refers to the chamber containing a predefined quantity of antibodies required for the assay process using the sensor disc assembly. It may be appreciated that the predefined quantity of antibodies is depended on the volume of the first cavity or the second cavity. Optionally, a volume of the second cavity may be same or smaller than the volume of the first cavity. The term “third cavity” as used herein refers to the chamber that receives at least partially the volume of sample fluid mixed with the antibodies from the second cavity via the fourth channel and/or at least partially the volume of sample fluid from the first cavity via the third channel.

Moreover, at least partially the volume of the sample fluid from the first cavity flows into the second cavity to mix with the antibody therein, when the third chamber is shut or closed. In this regard, a part of the volume of the sample fluid from the first cavity flows towards the third cavity by the third channel and upon finding no entry point for the third cavity, said volume of the sample fluid inside the third channel diverts and flows in to the second cavity by (via) the fourth channel. Optionally, the antibodies in the second cavity are in one of: liquid form, or solid form. It may be appreciated that the liquid or solid form of the antibodies play a crucial role in the detection and analysis of specific target analytes within the sample fluid. In this regard, the liquid antibodies facilitate homogeneous sample mixing, while solid antibodies provide stability and long-term storage capability, catering to diverse analytical needs. Beneficially, the antibodies available in either liquid form or solid form allows for flexibility in the assay design and implementation, accommodating various assay formats and requirements.

Optionally, the third channel is a branch channel of the fourth channel and the fluidic connection between the first cavity and the second cavity is via the third channel and the fourth channel. It may be appreciated that the third channel and the fourth channel are fluidically connected to each other, besides their respective fluidic connections with the first cavity and the second cavity. The fluidic architecture of the sensor disc assembly is designed such that the third channel functions as a branch channel of the fourth channel. Such configuration establishes a fluidically connected pathway between the first cavity and the second cavity, such that the sample fluid, upon entering the first cavity, can flow seamlessly to the second cavity via both the third and fourth channels, facilitating efficient mixing and interaction with the antibodies contained therein, when the third cavity is closed using a respective actuator. Beneficially, branching of the third channel from the fourth channel enables parallel fluid pathways, enhancing operational efficiency and reducing processing time.

Furthermore, the mixture of the sample fluid and the antibody is transferred to the expansion cavity by the fifth channel and back into the second cavity therefrom. The term “expansion cavity” refers to the chamber that is configured to be contracted and expanded to move the mixture of the sample fluid and the antibody back and forth between the second cavity and the expansion cavity, repeatedly (or iteratively, thereby rinsing the second cavity. In this regard, expansion cavity provides space for the a given volume of the mixture of sample fluid and antibody to expand and contract during different stages of the analysis. It may be appreciated that a volume of the expansion cavity is larger than the first and the second cavities, beneficially, allowing volume adjustment, accommodating varying sample sizes and enhancing analytical flexibility. Moreover, the third, fourth and fifth channels may also be microfluidic channels, similar to the first channel, with cross-sectional diameters similar or different as compared to the first channel.

Optionally, the expansion cavity comprises a spring-loaded piston to provide a first force to decrease a volume of the expansion cavity after expansion. The expansion cavity incorporates a spring-loaded piston mechanism to regulate the expansion cavity volume. Notably, the spring-loaded piston mechanism applies a controlled force, namely the first force, to adjust the expansion cavity's volume, allowing precise manipulation of the volume of the mixture of sample fluid and antibody within the assembly. Beneficially, the spring-loaded piston mechanism ensures precise control over the expansion cavity volume, enabling accurate sample fluid-antibody mixture manipulation. Moreover, the spring-loaded piston enables maintaining optimal conditions for analysis.

Optionally, the expansion cavity is configured to rinse the second cavity at least once. In an example, the expansion cavity is configured to rinse the second cavity twice. In an example, the expansion cavity is configured to rinse the second cavity thrice. Beneficially, the expansion cavity enables the sample fluid from the first cavity and the antibodies from the second cavity to mix properly, enabling accurate analysis of the sample fluid. Beneficially, the similar or narrower cross-sectional diameters of the fifth channel compared to the first channel allows pressurized mixing of the sample fluid and the antibody between the expansion cavity and the second cavity.

Furthermore, the cavity plate comprises an exit aperture fluidically connected to the third cavity by a sixth channel; and the first set of cavities containing reagents or enzyme substrates and fluidically connected to the exit aperture by respective first set of channels. The term “exit aperture” as used herein refers to the outlet that leads the mixture of the sample fluid and antibodies to transfer from the third cavity to the sensors via the sixth channel. Herein, the exit aperture is designed as a fluidic manifold that receives flow of fluids, such as sample fluid mixed with antibodies, reagents, enzyme substrates from their respective cavities, namely, the third cavity and the first set of cavities (e.g., a fourth cavity comprising a first reagent, a fifth cavity comprising a second reagent, a sixth cavity comprising an enzyme, and so on). Optionally, the sample fluid mixed with antibodies may flow into said first set of cavities (e.g., a fourth cavity comprising a first reagent, a fifth cavity comprising a second reagent, a sixth cavity comprising an enzyme, and so on) by respective first set of channels, namely, an seventh channel, an eighth channel, a ninth channel, and so on, prior to exiting on to the sensor layer of the sensor disc assembly. It may be appreciated that the sixth, seventh, eighth channel, and ninth channels may also be fluidic channels, similar to the first channel, with cross-sectional diameters similar or different as compared to the first channel.

It may be appreciated that a volume of the fourth and fifth cavities may be larger than the volume of the remaining cavities, to ensure holding larger volumes of the reagents and enzyme substrates to ensure accurate dilution and reaction with the antibodies mixed with the sample fluid, thereby accurate analysis of the sample fluid. Optionally, the desired reagents and enzyme substrates can be provided in a compressible, breakable ampoule or such in order to be squeezed into the respective first set of cavities and subsequently via the respective first set of channels to the sensor using a predefined amount of respective external forces. In one embodiment, the desired reagents and enzyme substrates may be provided in solid but soluble form such as salts.

It may be appreciated that the various cavities of the cavity plate may be of varying polygonal shape and sizes. Moreover, the lid part comprises a plurality of holes, corresponding to the various cavities of the cavity plate, such that top portions of the various cavities of the cavity plate are accessible via the respective holes on the lid part. In an example, a sample hole is carved in the lid part such that when the lid part and the base part are in the second configuration, the sample hole is adjacent to the sample cavity allowing an access to the sample cavity.

Furthermore, the sensor disc assembly comprises the sensor layer comprising the volume, wherein the fluids are provided to the volume from the exit aperture; and the sensor arranged to measure properties of fluids in the volume, when in use. Herein, the term “sensor layer” is a specific part of the sensor disc assembly, which contains one or more sensors in the volume (a defined space) thereof. It may be appreciated that the volume of the sensor layer comprises receives the fluids, namely the mixture of sample fluid and antibody, the enzyme substrate, and the reagents for sample fluid characteristics measurement, and cleaning of the sensor layer, respectively. The sensor layer is arranged along the base part of the sensor disc assembly such that the outer side of the cavity plate faces the volume of the sensor layer. Optionally, the one or more sensors may be arranged at a bottom surface of the sensor layer or on side walls of the sensor layer.

Alternatively, optionally, the one or more sensors are arranged on any of: the microfluidic plate, the inner side of the base part or the outer side of the base part. In this regard, the one or more sensors may be coupled directly to the ends of the fluidic channels, herein, the sixth channel, present in the microfluidic plate, or the exit aperture on the cavity plate. Alternatively, the one or more sensors may be present on the inner side or the outer side of the base part and the microfluidic plate is placed on top of a layer comprising the at least one sensor, and the sample fluid is channelized to the one or more sensor through the microfluidic plate. Optionally, when the number of sensors is more than two, the sensors are arranged in a ring-like pattern or any other suitable pattern corresponding to a pattern of the fluidic channels of the microfluidic plate. Further optionally the one or more sensors can be arranged as combination of the microfluid plate and the inner side of the base part. Plate can be fluid plate (such as milli fluid plate having larger structures).

Beneficially, the volume of the sensor layer and arrangement of the one or more sensors enable comprehensive sample fluid property measurements, ensuring thorough analysis of sample fluid characteristics.

Optionally, the cavity plate further comprises a flexible membrane covering at least partly the cavity plate or a set of flexible membranes covering respective cavities. In addition to the aforementioned features, the cavity plate of the sensor disc assembly may incorporate a flexible membrane, either partially or entirely covering its surface. Optionally, the flexible membrane is arranged in the lid part such that the position of the flexible membrane is relatively aligned with the sample collection part received in the sample cavity. Moreover, the flexible membrane is configured to receive an external force thereon and exert pressure over the sample collection part to enable the flow of at least a part of the sample fluid towards the sensor. Optionally, the flexible membrane reverts back to its original position, upon removal of the force thereon, thus making the sensor disc assembly ready for use again. Alternatively, optionally, the apparatus is suitable for single (one-time per sample) use only. Beneficially, the flexible membrane enhances the versatility and functionality of the sensor disc assembly.

Optionally, the flexible membrane or at least some of flexible membranes of the set of flexible membranes is/are removably attached to the cavity plate. The flexible membrane is designed to be removably attached to the cavity plate, to facilitate easy replacement or maintenance of the membrane as needed, ensuring the longevity and efficiency of the sensor disc assembly.

Optionally, the flexible membrane is made of an elastic material selected from a group of a plastic material, a silicone material, a rubber material. Herein, any of the plastic material, the silicone material or the rubber material provides an elastic property to the flexible membrane. Moreover, it will be appreciated that the plastic material, the silicone material or the rubber material is an inert material that is non-reactive with the sample fluid and any of the aforementioned components of the sensor disc assembly.

Optionally, the sample cavity comprises a filter to filter the sample fluid prior to providing the sample fluid to the first cavity, wherein the filter is selected from a group of a fiber filter, a fiberglass filter, a natural porous material, a natural fiber material, a synthetic porous material or a synthetic fiber material. Herein, the term “filter” refers to a porous material that allows the sample fluid to pass through it selectively when the sensor disc assembly is intended to be used and further prevents any solid particle or contamination in the sample fluid from flowing from the plurality of cavities in the cavity plate towards the microfluidic plate and consequently to the sensor. Moreover, the filter ensures that the sample fluid is evenly spread to the microfluidic plate and consequently to the sensor. Optionally the first cavity comprises a filter via which the sample is forced when the sample is forwarded to next phase of the sample handling process.

Notably, the fiber filter, the fiberglass filter, and other suitable filters are highly porous with a very small pore size ranging from 15-100 micrometers (μm) that can filter out smaller particles. Beneficially, the aforementioned material, such as fiber, fiberglass, natural porous materials, or synthetic fibers, ensures the quality and purity of the sample fluid for accurate analysis.

Optionally, the filter comprises a chemical to control the flow of at least a part of the sample fluid. Optionally, the chemical may be in the form of a soap solution or any other suitable chemical that can control the flow of at least a part of the sample fluid, i.e., the sample fluid does not too early or accidentally penetrates the microfluidic channels. Beneficially, the chemical makes saliva more reactive or otherwise more suitable for analysis.

Optionally, at least one of the first set of channels comprises a hydrophobic chamber. The term “hydrophobic chamber” typically refers to a sealed enclosure or container with hydrophobic properties, that is designed to repel or resist the penetration of water or aqueous solutions. The hydrophobic chamber is arranged between the first set of cavities and their respective first set of channels. Such configuration prevents accidental penetration of the volume of the mixture of the sample fluid and antibodies in the first set of cavities or penetration of the volume of the reagents and enzyme substrates from the first set of cavities to the volume of the mixture of the sample fluid and antibodies flowing in the sixth channel or at the exit aperture. Optionally, at least one of the channels within the first set of channels comprises a hydrophobic chamber. Alternatively, optionally, all of the first set of channels comprise a respective hydrophobic chamber. Beneficially, the hydrophobic chamber(s) enhances fluid handling capabilities, particularly in controlling the movement and directionality of hydrophilic fluids within the sensor disc assembly.

Optionally, the sensor disc assembly further comprises an identification code selected from a group of a quick response (QR) code, a Radio Frequency Identification (RFID) code, a barcode. Herein, the term “identification tag” refers to a tag that is used for identifying an authenticity of the sensor disc assembly, thus ensuring that an unauthentic or a low-quality sensor disc assembly is not being used. Optionally, the identification code may be provided at the base part of the sensor disc assembly, specifically at the outer side of the base part.

The present disclosure also relates to the analyzer as described above. Various embodiments and variants disclosed above, with respect to the aforementioned sensor disc assembly, apply mutatis mutandis to the analyzer.

The term “analyzer” refers to a sophisticated instrument designed for the efficient and accurate analysis of biological sample fluids. The analyzer is implemented as a casing that comprises a first part and a second part. Herein, the term “first part” refers to a hollow part having an inner side and an outer side, where the inner side of the first part has the electrical interface, arranged on the inner side of the first part, to connect with the sensor of the sensor layer of the aforementioned sensor disc assembly, when in use. The second part, at least partially detachably coupled to the first part, comprises an inner side and an outer side, opposite to the inner side, wherein the inner side of the second part faces the inner side of the first part when the second part is coupled to the first part. It will be appreciated that a second boundary wall of the second part is able to move nearer to and farther from a first boundary wall of the first part when the second part and the first part are brought closer together to obtain a first direction (i.e. closed configuration) or moved apart in a second direction (i.e. opened configuration).

Moreover, the second part comprises the set of actuators, wherein the set of actuators is configured to exert force towards the first part when the first part and the second part are moved towards each other for the an amount of distance. Herein, the term “set of actuators” refers to a part having a defined shape and thickness and is extruding out from the first side of the second part in a specific direction, i.e., towards the inner side of the first part.

Optionally, the set of actuators is coupled to the second part with a spring, the spring being arranged to press the set of actuators towards the first part with a first amount of force when the second part is moved a first amount of distance. Herein, coupling the set of actuators to the second part with the spring, allows the set of actuators to have a contracting and relaxing motion thus allowing the set of actuators to be pressed towards the first part with the first amount of force on moving the second part by the first amount of distance.

Optionally, the set of actuators is coupled to the second part with a spring, the spring being arranged to press the set of actuators towards the first part with a second amount of force when the second part is moved a second amount of distance. Similarly, the set of actuators is pressed towards the first part with the second amount of force on moving the second part by the second amount. Herein the second amount of distance is different from the first amount of distance.

Optionally, the first part and the second part are rotatable relative to each other, and wherein a rotational movement of the first part relative to the second part in the first direction causes the set of actuators to provide the first amount of force towards the compressible region when in use. In this regard, the movement of the first boundary wall of the first part relative to the second boundary wall of the second part is in the form of a rotational movement (such as twisting relative to each other) resulting in the first boundary wall and the second boundary wall to come nearer or farther to each other based on the direction of rotation of the first part relative to the second part. Specifically, the rotational movement of the first part relative to the second part in the first direction and a second direction causes the first part and the second part to move nearer to or farther away from each other, respectively.

Alternatively, optionally, the first part and the second part are movable laterally relative to each other. In this regard, the movement of the first boundary wall of the first part relative to the second boundary wall of the second part is in the form of a lateral movement. Herein, the lateral movement of the first part relative to the second part in the first direction and the second direction causes the first part and the second part to move nearer to or farther away from each other, respectively.

The analyzer comprises the slot for receiving the aforementioned sensor disc assembly of the first aspect. In this regard, the analyzer features a designated slot, within the casing thereof, where the sensor disc assembly, consisting of the cavity plate and the sensor layer, can be securely placed. The slot is arranged between the first part and the second part to receive the sensor disc assembly such that the lid part of the sensor disc assembly is configured to receive the force of the set of actuators when in use, and the base part of the sensor disc assembly sits against the first part of the analyzer such that the electrical interface contact the sensor of the sensor layer of the sensor disc assembly. The slot may receive the sensor disc assembly by sliding or placing the sensor disc assembly therein. When the sensor disc assembly is received in the slot, the first boundary wall is completely attached to the second boundary wall for using the analyzer and the sensor disc assembly for analysis of the sample fluid in the sensor disc assembly. Beneficially, the slot ensures proper alignment and connection between the sensor disc assembly and the analyzer.

Moreover, the set of actuators exert force to cavities of the cavity plate of the sensor disc assembly in a sequential manner to move fluids between the cavities by channels fluidically connecting the cavities. The term “set of actuators” refers to an array of actuators strategically positioned within the analyzer. These actuators are responsible for exerting forces to the cavities of the cavity plate in a sequential manner, thereby facilitating the movement of fluids between the cavities via channels fluidically connecting them. The sequential activation of these actuators is crucial for precise fluid manipulation during the analysis process. In this regard, the set of actuators are arranged such that an actuator from amongst the set of actuators is positioned adjacent to a given cavity of the cavity plate to access said cavity via the respective holes on the lid part. In an example, a sample press actuator for actuating the sample cavity is placed adjacent to the sample cavity such that the sample press actuator advances through a corresponding sample hole in the lid part to access the sample cavity to exert a force thereon, when in use. Herein, the phrase “sequential manner” refers to specific steps to perform the analysis process by sequential actuation of various cavities to enable the sample fluids to move between the cavities by respective channels fluidically connecting the cavities.

Optionally, the actuators are selected from a set of: electrical actuators and manual actuator. The electrical actuator is a device that converts electrical energy into mechanical motion. Optionally, the electrical actuators are selected from a group comprising: linear actuators, rotary actuators, and solenoids. Beneficially, the electrical actuators have high precision, speed, and cam be controlled remotely through electrical signals. The manual actuator is operated by human force rather than electricity or any other external power source. It typically involves direct physical manipulation by an operator to initiate or control movement. Examples of manual actuators include hand cranks, levers, knobs, and handles. Manual actuators are often simple, reliable, and cost-effective solutions for applications where automation or electrical power is not required or feasible. Beneficially, the manual actuators offer manual control options for calibration, troubleshooting, and maintenance, ensuring operational robustness and user accessibility.

Beneficially, the aforementioned actuators ensure optimal performance and functionality of the analyzer, allowing for precise control and manipulation of fluids within the sensor disc assembly during the analysis process.

Moreover, the analyzer comprises an electrical interface to a sensor of the sensor layer. Herein, the term “electrical interface” refers to the wiring configurations configured to transmit electrical signals, from an external electrical source, to the sensor. The electrical interface is installed to power the sensor, thus, enabling the sensor to carry out its function of sensing and data collection. The electrical interface connected to the sensor enables the sensed data from the sensor to be subsequently analyzed by the analyzer. Optionally, the electrical interface is arranged on the outer side or the inner side of the analyzer.

Moreover, the analyzer comprises an interface to provide analysis results related to the sensor reading. The interface may include a display screen, buttons, or other interactive elements that enable users to access and interpret the analysis results conveniently.

Optionally, the sensor disc assembly is according to the first aspect. Herein, the analyzer is compatible with the aforementioned sensor disc assembly of the first aspect. Beneficially, said compatibility ensures that the analyzer can effectively interface with the aforementioned sensor disc assembly incorporating various features and functionalities, allowing for versatile and adaptable analysis capabilities.

Optionally, the sequential manner comprises steps of:
a sample sequence to extract a sample fluid from a sample collecting part or to extract the sample fluid provided to a sample feeding inlet;
a mixing sequence to mix the extracted sample fluid with antibodies of a second cavity; and
a sensor fill sequence to move the sample fluid mixed with antibodies and reagents and/or enzymes to a volume of the sensor layer.

In this regard, a sequence of steps of actuating various actuators corresponding to the various cavities to exert corresponding forces thereon to enable moving the sample fluid in between the various cavities further to the sensor. It may be appreciated that the corresponding forces may be of same or different magnitudes, based on the volume of the sample fluid, the volume of the corresponding cavity, the cross-sectional diameters of the corresponding channels, and so on. Furthermore the force can be applied as function of time i.e. for example increasing or decreasing from a first value to a second value over time.

The term “sample sequence” refers to an initial step that involves extracting the sample fluid from a sample collecting part. A series of actions, including exerting forces with different actuators, are performed to transfer the sample fluid to the cavities of the sensor disc assembly.

Optionally, the sample sequence comprises
(i) exerting a force with a third actuator to a third cavity of the cavity plate, to block a fluidic route from the third cavity to a sixth channel;
(ii) exerting a force to a sample cavity of the cavity plate with a sample press actuator, to extract the sample fluid from the sample collecting part, and to move the sample fluid to a first cavity of the cavity plate by a first channel, the first cavity being fluidically connected to an overflow cavity of the cavity plate by a second channel; and
(iii) exerting a force to an overflow actuator from amongst the set of actuators, to block the fluidic route via the second channel to the overflow cavity.

In this regard, the third cavity is blocked, with the third actuator advancing through a corresponding third hole in the lid part to access the third cavity, to receive or release sample fluid flowing therein through the third channel, until the sample fluid from the first cavity has mixed with the antibodies in the second cavity, and a proper mixing thereof has been ensured in the expansion cavity. The sample press actuator configured to actuate the sample cavity is operated to advance through the corresponding sample hole in the lid part to access the sample cavity to extract out sample from the sample collecting part into the sample cavity by exerting a force on the sample collecting part received by the sample cavity. Subsequently, the extracted sample fluid is sequentially moved to the first cavity when a corresponding first actuator thereto is operated, and so on. Subsequently, the overflow actuator advances through a corresponding overflow hole in the lid part to access the overflow cavity to exert a force to block the sample fluid to flow further into the overflow cavity from the first cavity, so as not to rinse the first cavity of the sample fluid.

Alternatively, the sample sequence comprises
(I) exerting a force to a blister unit arranged to cover the sample cavity to pump sample from a sample inlet and to move the sample to the first cavity for filtering and
(II) exerting a force to the first cavity to push the sample thru a filter housed in the first cavity via a third channel to an expansion cavity.

Moreover, the term “mixing sequence” refers to a subsequent step, following sample sequence, that involves exerting forces with different actuators to transfer the sample fluid to the cavities of the sensor disc assembly such that the sample fluid is transferred to the second cavity where it is mixed with antibodies. The mixing sequence ensures thorough and uniform distribution of antibodies throughout the sample fluid. It may be appreciated that the mixing sequence is repeated iteratively to ensure thorough mixing of the sample fluid and the antibodies.

Optionally, the mixing sequence comprises, to mix the sample fluid with antibodies:
(iv) exerting a force with a first actuator from amongst the set of actuators to the first cavity to move the sample fluid via a third channel to a second cavity of the cavity plate, and from the second cavity further, via a fourth channel to an expansion cavity of the cavity plate;
(v) removing the force exerted by the first actuator to the first cavity to move the sample fluid from the expansion cavity via the fourth channel to the second cavity and from the second cavity further to the first cavity; and
optionally repeating (iv) and (v) a plurality of times to ensure that the sample fluid is mixed with the antibodies at least by a predetermined degree.

In this regard, the first actuator is engaged to exert the force on to the first cavity, directing the sample fluid via a third channel to the second cavity and further to the expansion cavity via the fifth channel. Herein, the force causes the first cavity to rinse the sample fluid from the first cavity into the second cavity as the third cavity is blocked by the force exerted by the third actuator. Said force once removed causes the expansion cavity to return the mixture of sample fluid and antibodies back into the first cavity. It may be appreciated that the actuation of the first actuator may be performed a multiple times, to ensure thorough mixing of the sample fluid and the antibodies between the first and second cavities and the expansion cavity.

Alternatively, the mixing sequency comprises:
(III) exerting a force to the expansion cavity to move the sample from the expansion cavity via a fifth channel to a second cavity accommodating antibodies and further to a third cavity;
(VI) exerting a force to the third cavity to move the sample from the third cavity back to the expansion cavity via the second cavity and
(V) repeating steps III and VI a plurality of times.

Moreover, the term “sensor filling sequence” refers to a subsequent step, following sample sequence and the mixing sequence, that involves exerting forces with different actuators, to transfer the sample fluid mixed with antibodies, along with any additional reagents or enzymes, to the volume of the sensor layer of the sensor disc assembly. The sensor filling sequence ensures that the sensor layer is adequately filled with the prepared sample fluid for analysis.

Optionally, the sensor fill sequence comprises:
(vi) removing the force exerted by the third actuator to open the fluidic route from the third cavity to the sixth channel; and
(vii) exerting a force with the first actuator to the first cavity to move the sample fluid antibody mixture via the third channel to the third cavity and from the third cavity further, via a sixth channel to the volume of the sensor.

In this regard, the third actuator is disengaged with the third cavity to unblock the third cavity, to receive an incoming sample fluid mixed with antibodies by the third channel, i.e., from the first cavity or the fourth channel, of which the third channel is a branch channel. The first actuator is again engaged with the first cavity to exert force thereon to rinse the first cavity off the sample fluid mixed with the antibodies to transfer to the third cavity, and further to the volume of the sensor layer via the sixth channel.

Optionally, the sensor fill sequence comprises:
(viii) exerting a force with the first actuator to the first cavity to move the sample fluid via the third channel to the second cavity and from the second cavity further, via the fifth channel to the expansion cavity; and
(ix) removing the force exerted by the third actuator to open the fluidic route from the third cavity to the sixth channel to move the sample fluid from the expansion cavity via the fifth channel to the second cavity and from the second cavity further to the third cavity and from the third cavity further, via the sixth channel to the volume of the sensor layer.

In this regard, as mentioned above, the first actuator is engaged to exert the force on to the first cavity, directing the sample fluid via a third channel to the second cavity via the third channel and the fourth channel, and further to the expansion cavity via the fifth channel, when the third actuator is actuated to engage with the third cavity to block it from receiving or transferring the sample fluid (mixed with antibodies) to flow into the sixth channel. Once the sample fluid from the first cavity mixes thoroughly with the antibodies in the second cavity, the third actuator is disengaged with the third cavity to unblock the third cavity. Consequently, the sample fluid within the expansion cavity is allowed to flow back via the fifth channel to the second cavity. From the second cavity, the sample fluid is further directed to the third cavity via the third channel, i.e., via the first cavity or the fourth channel, of which the third channel is a branch channel. The mixture of sample fluid and antibodies received by the third cavity is further transferred to the volume of the sensor layer via the sixth channel. Beneficially, said sequence guarantees that the sensor layer is adequately filled with the prepared sample fluid for analysis.

Optionally, the sensor fill sequence further comprises
(x) extracting a force with at least one actuator associated with a first set of cavities, of the cavity plate, containing reagents or enzyme substrates to move respective reagents and/or enzymes to the volume of the sensor layer by respective first set of channels.

In this regard, it may be appreciated that during the sample sequence and mixing sequence, the first set of cavities are exerted with corresponding forces from corresponding first set of actuators. During the sensor fill sequence, the analyzer may include the extraction of forces with at least one actuator from amongst the first set of actuators associated with the first set of cavities of the cavity plate that contain reagents or enzyme substrates essential for the analysis process. By extracting forces with the designated actuators, the respective reagents and/or enzymes are directed to the volume of the sensor layer via the respective first set of channels, to ensure that the sensor is supplied with all necessary components for the analysis of the sample fluid.

Optionally, the expansion cavity moves the sample fluid away from the expansion cavity by means of at least one of: a piston, a flexible member, an expansion cavity actuator. The piston is a component that may snugly fit inside the expansion cavity to seal the expansion cavity entry/exit point to prevent sample fluid from entering/leaking therefrom. When pressure is applied to one side of the piston, it creates a force that pushes the piston in the opposite direction, to displace the sample fluid within the chamber, such that the sample fluid moves out of the expansion cavity into various cavities or channels of the sensor disc assembly. Similarly, when pressure is applied to the opposite side of the piston, it creates a force that pushes the piston in the other direction, to displace the sample fluid within the chamber, such that the sample fluid moves inside the expansion cavity from various cavities or channels of the sensor disc assembly.

The flexible member refers to a component that can deform or bend under applied force. This could include materials such as rubber, elastomers, or flexible membranes. Notably, the flexible member may be used to create a seal or barrier within a system, herein the expansion cavity. Typically, the flexible member could act as a valve or seal, preventing fluid from flowing back into the expansion cavity once it has been displaced. For example, it could be employed to seal off one section of the expansion cavity while allowing fluid flow in another direction.

The expansion cavity actuator is an actuator, similar to the aforementioned actuators, that engages with the expansion cavity specifically to modulate the expansion and contraction of the expansion cavity for rinsing the second cavity and the re-filling it, when the expansion cavity actuator engages and disengages with the expansion cavity respectively. Typically, the expansion cavity actuator utilizes changes in volume (resulting from changes in fluid volume, pressure, or temperature) within the expansion cavity to generate mechanical motion or force.

Beneficially, the aforementioned components for effectively moving the sample fluid away from the expansion cavity enable controlled displacement of the sample fluid, contributing to the accuracy and reliability of the analysis results obtained.

Moreover, the analyzer comprises a controller configured to obtain an indicator value related to the sensor of the sensor disc assembly. Herein, the term “controller” refers to a computing part present in the analyzer having processing capabilities. Optionally, the controllers include but is not limited to, a microcontroller, a processor, a microprocessor, a complex instruction set computing (CISC) microprocessor, a reduced instruction set (RISC) microprocessor, a very long instruction word (VLIW) microprocessor, Field Programmable Gate Array (FPGA) or any other type of controlling circuit, for example as aforementioned. In essence, the electrical interface is coupled with the controller. Herein, the term “indicator value” refers to a numerical value giving a certain indication related to the data of the certain property, such as the amount of the at least one molecule of interest in the sample fluid, which is being sensed by the sensor.

Optionally, the analyzer is configured to provide an electrical signal via the electrical interface to analyze fluids in the volume after the sensor fill sequence. The controller is configured to provide, via the electrical interface comprising plurality of electrical connectors, electrical signals to the sensor via the plurality of electrical connectors, and in turn receive a related electrical signal from the sensor. Herein, the term “related electrical signal” may preferably relate to signals corresponding to the change in electrical characters measured as the function of a data of a certain property, such as an amount of at least one molecule of interest in the sample fluid, by the sensor. Herein, the electrical signal may be associated with a sufficient volume of sample fluid mixed with antibodies, reagents and enzyme substrates reaching the sensor, and the related electrical signal is in a form readable by the controller. Said electrical signal facilitates the analysis of various properties and characteristics of the fluids, enabling the detection and quantification of specific analytes present within the sample fluid.

Subsequently, the controller uses the received indicator values for further analysis and for drawing out certain inferences related to the certain property of the sample fluid sensed by the sensor. Optionally, the analyzer further comprises a memory unit to store data corresponding to the received indicator value related to the sensor, data received from the sensor, and so forth.

Optionally, the analyzer is configured to use the electrical interface of the sensor to analyze the sample fluid of the sensor layer and provide the analysis results related to the sensor reading. Herein, through the electrical interface, the analyzer is capable of performing a comprehensive analysis of the sample fluid, detecting and quantifying various analytes present within the sample. Furthermore, the analyzer provides analysis results related to the sensor reading, enabling users to interpret and utilize the obtained data effectively.

Optionally, the analyzer further comprises a communication interface configured to provide the indicator value to a computing unit, wherein the computing unit is configured to analyze the indicator value to determine a significance of the amount of the at least one molecule of interest in the sample fluid. Herein, the term “computing unit” refers to a unit having processing capabilities. Optionally, the computing unit may be a cloud server, a database or a processor. The analyzer may transfer the information received from the sensor to the computing device for further processing and analysis of the information. Optionally, the computing unit may include, but is not limited to, cellular phones, personal digital assistants (PDAs), handheld devices, wireless modems, laptop computers, personal computers, and so forth. Alternatively computing of values and analyzing indicator values can be done in the analyzer.

Herein, the term “communication interface” refers to a means of communication that is used to communicate the indicator value to the computing unit. Optionally, the communication interface may be a wired or a wireless communication unit. Optionally, the communication interface may include, but is not limited to, Bluetooth®, Wireless Fidelity (Wi-Fi), Local Area Networks (LANs), Wide Area Networks (WANs), Metropolitan Area Networks (MANs), Wireless LANs (WLANs), Wireless WANS (WWANs), Wireless MANS (WMANS), the Internet, second generation (2G) telecommunication networks, third generation (3G) telecommunication networks, fourth generation (4G) telecommunication networks, fifth generation (5G) telecommunication networks and Worldwide Interoperability for Microwave Access (WiMAX) networks.

Beneficially, integration of the electrical interface enables real-time data acquisition and analysis, facilitating rapid and accurate assessment of the sample fluid characteristics. Moreover, direct sensor connectivity of the electrical interface enhances sensitivity and resolution, enabling detection of subtle changes in the sample fluid characteristics. Furthermore, analysis results provided through the electrical interface offer immediate feedback, enabling timely decision-making and action.

Optionally, the analyzer further comprises a charger for charging the analyzer. Herein, the analyzer may be configured to be charged from an external power source or an internal power source, such as a battery unit. In case of an internal battery unit, the internal battery unit may have a certain battery life and once the device is used for a time period the battery life exhausts, then the analyzer may again be recharged for further use via the charger. Herein, the charger may be a magnetic charger or a wired charger. Optionally, the analyzer may be charged when the device is in inactive mode.

Optionally, the analyzer is configured to attain a plurality of modes of operation selected from: an inactive mode, a feed mode having the first part and the second part arranged to provide the slot to receive the sensor disc assembly therein; and an analysis mode having the second part configured to move the first amount of distance relative to the first part to provide the first amount of force on the lid part of the sensor disc assembly.

In this regard, the term “inactive mode” refers to a resting mode in which the analyzer is not in use and the first boundary wall of the first part is attached to the second boundary wall of the second part such that there is no opening or slot visible between the first part and the second part. It will be appreciated that having the first boundary wall and the second boundary wall attached together prevents inner components of the analyzer, such as the electrical interface and the set of actuators, from being contaminated or losing their effectiveness due to moisture, dirt and such other factors.

Herein, the term “feed mode” refers to a first active mode in which the first boundary wall of the first part is moved farther away from the second boundary wall of the second part, thus arranging (namely, creating) the opening or slot between the first part and the second part for receiving the sensor disc assembly in the analyzer for analysis of the sample fluid in the sensor disc assembly.

Herein, the term “analysis mode” refers to a second active mode where the first boundary wall of the first part and the second boundary wall of the second part are made to move nearer to each other by the first amount of distance so that the set of actuators of the second part of the analyzer exerts the first amount of force on the lid part of the sensor disc assembly thus allowing the flow of at least a part of the sample fluid from the sample collection part to the sensor, in order for the sensor to sense the data of the certain property and the provide related electrical signal to the controller for further analysis thereof. An example of analyzing data associated with collected sample fluid is finding amount of hormones in the sample.

Optionally, the analyzer is configured to report the current mode of operation via at least one of: an LED module, a haptic module, or an acoustic module. Optionally, the LED module may be provided on the analyzer, such as on the outer side of the first part or the second part of the analyzer, to communicate the current mode of operation of the analyzer to the user. In this regard, the signal is a light signal that changes from one color (such as yellow) to another (such as red) based on the processing of the sample fluid in the sensor disc assembly, i.e., by the sensor, and in the analyzer. Herein, for example the ‘yellow’ color light signals the inactive mode, the ‘orange’ color light signals the feed mode and the ‘green’ color light signals the analysis mode. It will be appreciated that the user may be associated with a user device, namely the computing device, such as a smart phone, a laptop, or a server.

A technical effect of using different colour light indicators, or haptic or acoustic signals to indicate different mode of operations of the sensor disc assembly is that it enhances the functionality, user experience (by offering customization options for indicating modes), and safety of the sensor disc assembly. Particularly, different coloured lights, haptic feedback (vibrations or tactile sensations), or acoustic signals provide a clear and intuitive way to communicate to the user the current mode of operation. This reduces confusion and the risk of errors caused by misunderstanding the status of the sensor disc assembly. Moreover, in cases where the sensor disc assembly can be monitored remotely, different colored lights or auditory signals can provide real-time feedback to remote operators about the sensor disc assembly's current mode and status, for example in emergency or error situations. Furthermore, incorporating haptic and acoustic signals provides information to users who may have visual impairments, thus, making the sensor disc assembly more inclusive and usable by a wider range of individuals.

It may be appreciated that after the analysis, the used sensor disc assembly is returned back (in a return shipment bag) back to the source procurement site (i.e., the manufacturing company) for sustainable post processing, such as cleaning the sensor disc assembly thoroughly for reuse.

### DETAILED DESCRIPTION OF THE DRAWINGS

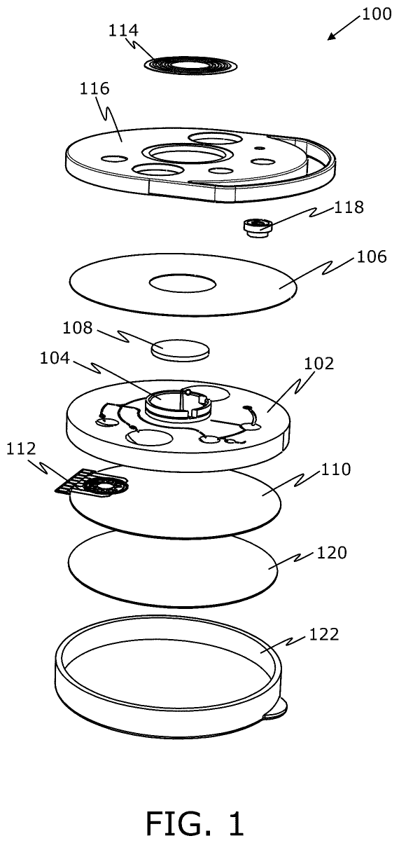

Referring to FIG. 1, illustrated is a schematic illustration of an exploded view of a sensor disc assembly 100, in accordance with an embodiment of the present disclosure. As shown, the sensor disc assembly 100 comprises a cavity plate 102 comprising a sample cavity 104 for receiving a sample collecting part containing a sample fluid. Moreover, the cavity plate 102 comprises a first cavity fluidically connected to the sample cavity by a first channel. Furthermore, the cavity plate 102 comprises an overflow cavity fluidically connected to the first cavity by a second channel. Furthermore, the cavity plate 102 comprises a second cavity containing antibodies and fluidically connected to the first cavity by a third channel. Furthermore, the cavity plate 102 comprises an expansion cavity fluidically connected to the second cavity by a fifth channel. Furthermore, the cavity plate 102 comprises a third cavity for accommodating the sample fluid mixed with antibodies and connected to the second cavity by a fourth channel. Furthermore, the cavity plate 102 comprises an exit aperture fluidically connected to the third cavity by a sixth channel. Furthermore, the cavity plate 102 comprises a first set of cavities containing reagents or enzyme substrates and fluidically connected to the exit aperture by respective first set of channels.

Optionally, the cavity plate 102 further comprises a flexible membrane 106 covering at least partly the cavity plate 102 or a set of flexible membranes covering respective cavities. The flexible membrane covers channels and the cavities (except for sample cavity). Benefit of the flexible member is that antibodies, reagents and enzymes are protected from ambient conditions. Optionally, the sample filter 104 comprises a filter 108 to filter the sample fluid prior to providing the sample fluid to the first cavity. Moreover, the sensor disc assembly 100 comprises a sensor layer 110 comprising a volume, wherein the fluids are provided to the volume from the exit aperture, and a sensor 112 arranged to measure properties of fluids in the volume, when in use. Furthermore, the sensor disc assembly 100 comprises a sample press flexible seal window 114, a lid part 116 comprising a plurality of holes through which various cavities of the cavity plate 102 are accessible, an expansion cavity frame 118, an absorbent membrane 120, and a base part 122.

FIG. 1 is merely an example, which should not unduly limit the scope of the claims herein. A person skilled in the art will recognize many variations, alternatives, and modifications of embodiments of the present disclosure.

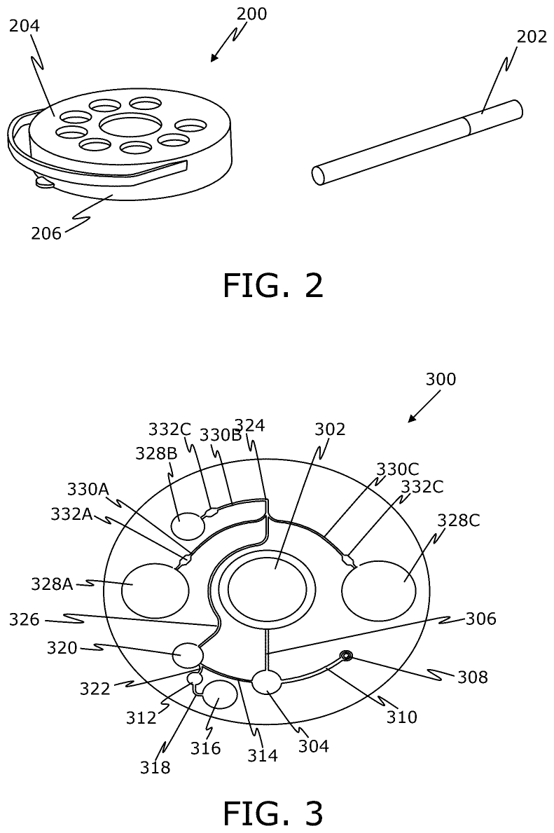

Referring to FIG. 2, illustrated is a schematic illustration of a sensor disc assembly 200 in use with a sample collecting part 202, in accordance with an embodiment of the present disclosure. As shown, the sensor disc assembly 200 comprises a lid part 204 and a base part 206. Moreover, the sensor disc assembly 200 collects a sample fluid from the sample collecting part 202, by receiving the sample collecting part 202 in a cavity plate of the sensor disc assembly 200.

FIG. 2 is merely an example, which should not unduly limit the scope of the claims herein. A person skilled in the art will recognize many variations, alternatives, and modifications of embodiments of the present disclosure.

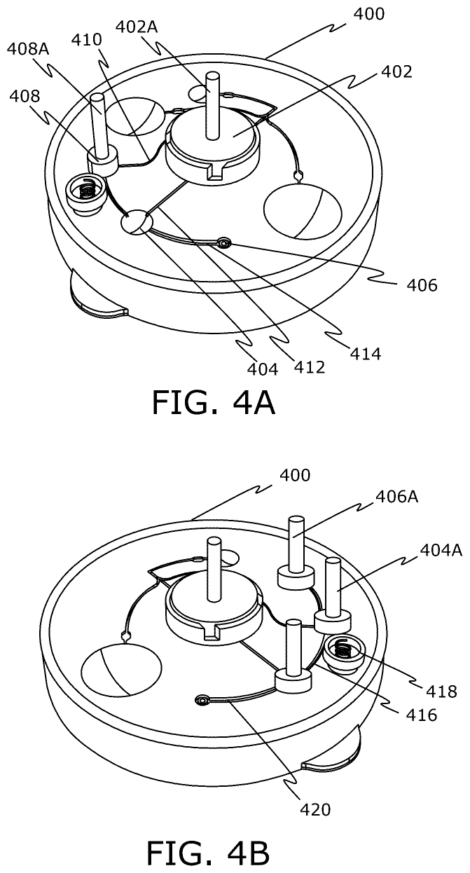

Referring to FIG. 3, illustrated is a schematic illustration of a cavity plate 300, in accordance with an embodiment of the present disclosure. As shown, the cavity plate 300 comprises a sample cavity 302 for receiving a sample collecting part containing a sample fluid. Moreover, the cavity plate 300 comprises a first cavity 304 fluidically connected to the sample cavity 302 by a first channel 306. Furthermore, the cavity plate 300 comprises an overflow cavity 308 fluidically connected to the first cavity 304 by a second channel 310. The overflow cavity provide a fluidic route/drain to absorbent membrane to collect possible excess sample fluid. Furthermore, the cavity plate 300 comprises a second cavity 312 containing antibodies and fluidically connected to the first cavity 304 by a third channel 314. The antibodies can be provided to the second cavity as in a liquid carrier or as solid (powder). Benefit of solid form is that the sensor disc can be stored for longer time than if the antibodies are in the liquid carrier. Furthermore, the cavity plate 300 comprises an expansion cavity 316 fluidically connected to the second cavity 312 by a fifth channel 318. Furthermore, the cavity plate 300 comprises a third cavity 320 for accommodating the sample fluid mixed with antibodies and connected to the second cavity 312 by a fourth channel 322. Furthermore, the cavity plate 300 comprises an exit aperture 324 fluidically connected to the third cavity 320 by a sixth channel 326. Furthermore, the cavity plate 300 comprises a first set of cavities (depicted as cavities 328A, 328B, 328C) containing reagents or enzyme substrates and fluidically connected to the exit aperture 324 by a respective first set of channels (depicted as channels 330A, 330B, 330C). Moreover, the at least one of the first set of channels 330A, 330B, 330C comprises a hydrophobic chamber 332A, 332B, 332C.

FIG. 3 is merely an example, which should not unduly limit the scope of the claims herein. A person skilled in the art will recognize many variations, alternatives, and modifications of embodiments of the present disclosure.

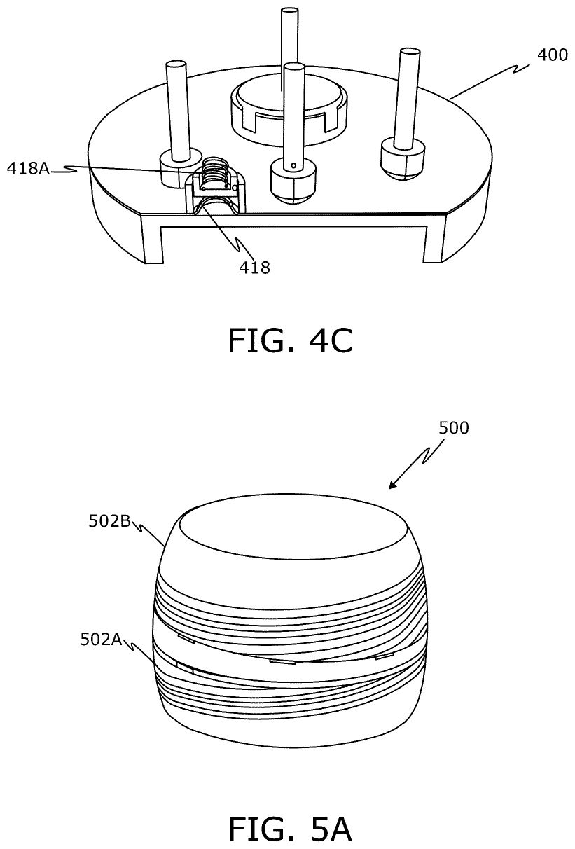

Referring to FIGS. 4A and 4B, illustrated are schematic illustrations of an interaction between the cavity plate 400 and the set of actuators 402A, 404A, 406A and 408A, when in use, in accordance with an embodiment of the present disclosure. Herein, the set of actuators 402A, 404A, 406A and 408A arranged on the analyzer (not shown), when in use, exert force to cavities of the cavity plate of the sensor disc assembly in sequential manner to move fluids between the cavities by channels fluidically connecting the cavities cavity plate 400. The actuators can be for example controlled with a step motor or those can be implemented as solenoids. Actuator head part (which is pressing the cavity) is dimensioned and has a formfactor which enables it to penetrate to the cavity. As shown in FIG. 4A, a sample sequence to extract a sample fluid from a sample collecting part is depicted. As shown, the sample sequence comprises exerting a force with a third actuator 408A to a third cavity 408 of the cavity plate 400, to block a fluidic route from the third cavity 408 to a sixth channel 410; exerting a force to a sample cavity 402 of the cavity plate 400 with a sample press actuator 402A, to extract the sample fluid from the sample collecting part, and to move the sample fluid to a first cavity 404 of the cavity plate 402 by a first channel 412, the first cavity 404 being fluidically connected to an overflow cavity 406 of the cavity plate 404 by a second channel 414; and exerting a force to an overflow actuator 406A from amongst the set of actuators 402A, 404A, 406A and 408A, to block the fluidic route via the second channel 414 to the overflow cavity 406.

As shown in FIG. 4B, a mixing sequence to mix the extracted sample fluid with antibodies of a second cavity and a sensor fill sequence to move the sample fluid mixed with antibodies and reagents and/or enzymes to a volume of the sensor layer (not shown) are depicted. As shown, the mixing sequence comprises, to mix the sample fluid with antibodies, exerting a force with a first actuator 404A from amongst the set of actuators 402A, 404A, 406A and 408A to the first cavity 404 to move the sample fluid via a third channel 416 to a second cavity (not visible between the third cavity 408 and an expansion cavity 418) of the cavity plate 400, and from the second cavity further, via a fourth channel (not visible between the third cavity 408 and the second cavity) to the expansion cavity 418 of the cavity plate 400; removing the force exerted by the first actuator 404A to the first cavity 404 to move the sample fluid from the expansion cavity 418 via the fifth channel (not shown between the expansion cavity 418 and the second cavity) to the second cavity and from the second cavity further to the first cavity 404; and optionally repeating the above steps a plurality of times to ensure that the sample fluid is mixed with the antibodies at least by a predetermined degree. The expansion cavity is covered with the flexible membrane. The flexible membrane expands during a sequence in which sample fluid is moved to the expansion cavity. The expansion cavity is covered with a spring system which provides a force to the expansion cavity. As the force is removed (by lifting the actuator up) then force from the spring and the flexible member forces the sample fluid (mixed with antibodies) to move via the second cavity towards the first cavity. Alternatively to spring setup an actuator could be arranged to empty (at least partly) the expansion cavity.

Moreover, as shown, the sensor fill sequence comprises removing the force exerted by the third actuator 408A to open the fluidic route from the third cavity 408 to the sixth channel 410; and exerting a force with the first actuator 404A to the first cavity 404 to move the sample fluid antibody mixture via the third channel 416 to the third cavity 408 and from the third cavity further, via a sixth channel 420 to the volume of the sensor (not shown). Alternatively force of the spring system in the expansion cavity could be used to move the mixture to the sensor.

FIGS. 4A and 4B are merely examples, which should not unduly limit the scope of the claims herein. A person skilled in the art will recognize many variations, alternatives, and modifications of embodiments of the present disclosure.

Referring to FIG. 4C, illustrated is a schematic illustration of the expansion cavity 418 of the cavity plate 400, in accordance with an embodiment of the present disclosure. The expansion cavity 418 comprises a spring loaded piston 418A to provide a first force to decrease a volume of the expansion cavity 418 after expansion. The decrease of the volume leads to movement of the mixture of sample and antibodies.

FIG. 4C is merely an example, which should not unduly limit the scope of the claims herein. A person skilled in the art will recognize many variations, alternatives, and modifications of embodiments of the present disclosure.

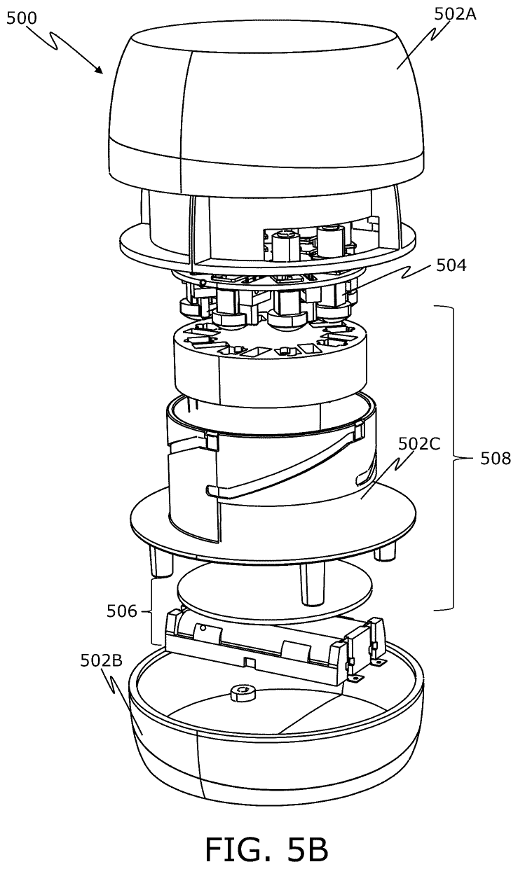

Referring to FIG. 5A, illustrated is a schematic illustration of an analyzer 500, in accordance with an embodiment of the present disclosure. As shown, the analyzer 500 is implemented as a casing comprising a first part 502A and a second part 502B that is at least partially detachably coupled to the first part 502A.

Referring to FIG. 5B, illustrated is a schematic illustration of an exploded view of the analyzer 500, in an open configuration thereof, in accordance with an embodiment of the present disclosure. As shown, the analyzer 500 implemented as a casing comprising a first part 502A and a second part 502B that is at least partially detachably coupled to the first part 502A. The analyzer 500 comprises a slot 502C for receiving a sensor disc assembly (such as the sensor disc assembly 100 or 200 of FIG. 1 or 2, the sensor disc assembly having a cavity plate and a sensor layer. Moreover, the analyzer 500 comprises a set of actuators 504 arranged on the analyzer 500, when in use, to exert force to cavities of the cavity plate of the sensor disc assembly in a sequential manner to move fluids between the cavities by channels fluidically connecting the cavities. Furthermore, the analyzer 500 comprises an electrical interface 506 to a sensor of the sensor layer. Furthermore, the analyzer 500 comprises an interface (not shown) to provide analysis results related to the sensor reading. As shown, the analyzer 500 comprises set of actuators 504 and an electrical interface 506 in an inner casing 508, between the first part 502A and the second part 502B. The actuators are controlled with a controller programmed to move the actuators towards (to exert force) the cavity plate of the sensor disc assembly and to move the actuators away from the cavity plate (remove force).

FIGS. 5A and 5B are merely examples, which should not unduly limit the scope of the claims herein. A person skilled in the art will recognize many variations, alternatives, and modifications of embodiments of the present disclosure.

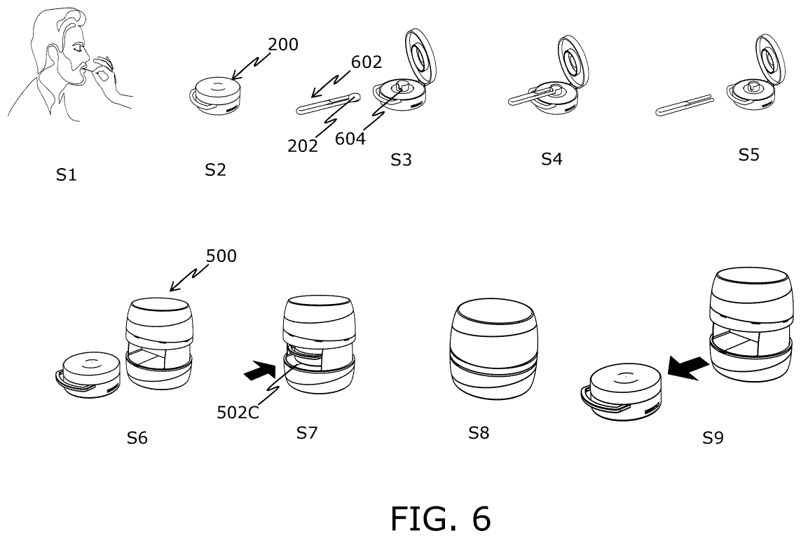

Referring to FIG. 6, illustrated is a schematic illustration of an implementation of the sensor disc assembly 200 and the analyzer 500, in accordance with an embodiment of the present disclosure. At step S1, a sample fluid is collected from a person using a sample collecting part 202 of a sample stick 602. At step S2, the sensor disc assembly 200 is unwrapped to be used. At step S3, the sensor disc assembly 200 is opened and the sample stick 602 is advanced towards the opened sensor disc assembly 200. At step S4, the sample stick 602 is arranged on the opened sensor disc assembly 200 such that the sample collecting part 202 is received by the sample cavity 604 of the sensor disc assembly 200. At step S5, the sample stick 602 sans the sample collecting part 202 is pulled out of the sensor disc assembly 200, such that the sample collecting part 202 remains on the sample cavity 604. At step S6, the analyzer 500 is twisted open to expose the slot 502C to receive the sensor disc assembly 200 therein. At step S7, the sensor disc assembly 200 is inserted in the slot 502C of the analyzer 500. At step S8, the analyzer 500 is closed to analyze the sample fluid in the sensor disc assembly 200, by twisting back the analyzer 500. At step S9, the analyzer 500 is opened to eject or pull out the sensor disc assembly 200, after the analysis.

FIG. 6 is merely an example, which should not unduly limit the scope of the claims herein. A person skilled in the art will recognize many variations, alternatives, and modifications of embodiments of the present disclosure.

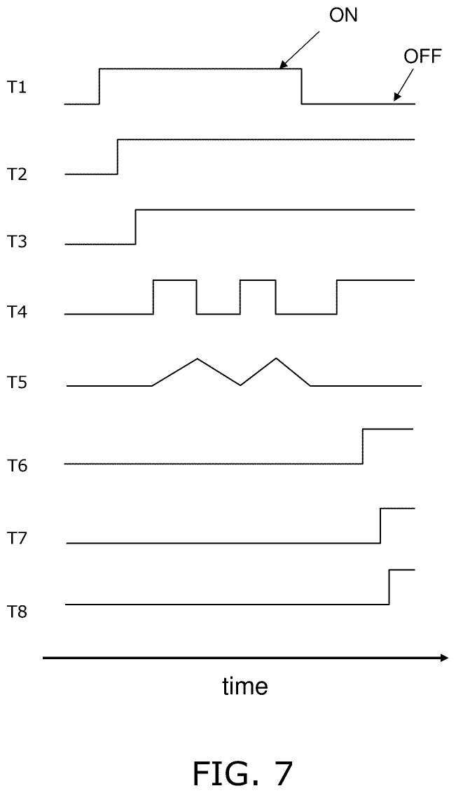

Referring to FIG. 7, illustrated is a schematic illustration of a timeline of actuating various actuators from amongst a set of actuators of the analyzer 500, in accordance with an embodiment of the present disclosure. T1 is illustration of a timing of applying force with a third actuator. Force is illustrated in the figure to be “on” (i.e the actuator is pressing respective cavity) when the line is up and force is “off” (i.e. actuator is not pressing respective cavity) when the line is down. The sequence starts by exerting a force with the third actuator to a third cavity of the cavity plate, to block a fluidic route from the third cavity to a sixth channel; subsequently, a force is exerted to a sample cavity of the cavity plate with a sample press actuator (T2), to extract the sample fluid from the sample collecting part, and to move the sample fluid to a first cavity of the cavity plate by a first channel, the first cavity being fluidically connected to an overflow cavity of the cavity plate by a second channel. As illustrated the sample press actuator force is applied after closing the third cavity with the third actuator. The force on the sample press actuator is left on. The sample press actuator can be manual actuator according to one embodiment. Since channel to the overflow channel is open excess sample fluid will flow to the overflow channel After exerting the force to the sample cavity (T2) a force (T3) is exerted by an overflow actuator from amongst the set of actuators to overflow cavity, to block the fluidic route via the second channel to the overflow cavity. Force applied to the sample cavity and to the overflow cavity is left “on” for rest of duration of the measurement sequence.

During a mixing sequence to mix the sample fluid with antibodies, a force (T4) is exerted with a first actuator from amongst the set of actuators to the first cavity to move the sample fluid via a third channel to a second cavity of the cavity plate, and from the second cavity further, via a fourth channel to the expansion cavity of the cavity plate; the force removed exerted by the first actuator to the first cavity to move the sample fluid from the expansion cavity via the fifth channel to the second cavity and from the second cavity further to the first cavity, respectively; and optionally repeating the above steps a plurality of times to ensure that the sample fluid is mixed with the antibodies at least by a predetermined degree. Line T5 is an illustration of a fill rate of the expansion cavity. As it can be seen the expansion cavity fills in as function of time as the force is exacted to the first cavity. As the force is removed from the first cavity then the expansion cavity empties. This back-and-forth movement of sample fluid via the second cavity (in which antibodies are) enables efficient way to ensure that antibodies are mixed with the sample fluid in uniform way. Also, in case antibodies are in sold form and attached initially to walls of the second cavity, it enables to dissolve those in efficient way to the sample fluid. In the example of the figure expansion cavity is filled two times. After that the third actuator, which is blocking route to the sixth channel (as pressed to the third cavity) is moved up (force is taken off). Now as the first actuator is pressed down to the first cavity the mixture of sample fluid and antibodies move towards the sensor via the sixth channel.

Furthermore, from T6, T7 and T8 illustrate forces applied with actuators associated with actuators containing reagents and enzymes, during the sensor fill a force with at least one actuator, namely a fourth actuator, a fifth actuator and a sixth actuator from amongst the first set of actuators, associated with a fourth cavity, a fifth cavity and a sixth cavity from amongst a first set of cavities, of the cavity plate, containing reagents or enzyme substrates, is extracted to move respective reagents and/or enzymes to the volume of the sensor by respective first set of channels.

It may be appreciated that the order of the sequence of steps T6-T8 of the timeline may vary depending on the analysis.

FIG. 7 is merely an example, which should not unduly limit the scope of the claims herein. A person skilled in the art will recognize many variations, alternatives, and modifications of embodiments of the present disclosure.

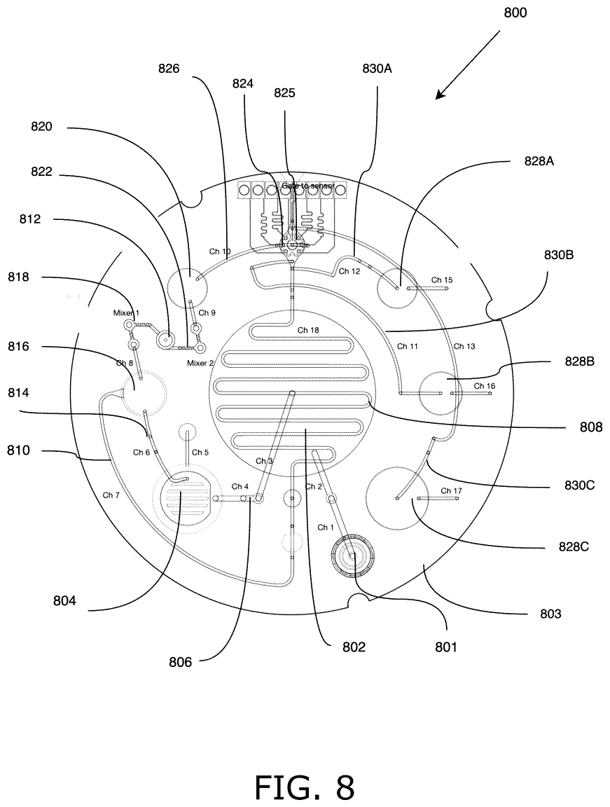

FIG. 8 is an illustration of a sensor disc assembly 800 according to an alternative embodiment. The sensor disc assembly 800 comprises a cavity plate 803. The cavity plate comprises a set of cavities. The cavities are interconnected with respective channels to move the sample from one cavity to another when the sensor disc assembly 800 is used (with an analyzer). The sample is provided via a sample feeding inlet 801. A hose or a pipe is connected to the sample feeding inlet 801 via which the sample is delivered to the sample feeding inlet 801. User of the device places other end of the hose in a mouth. A blister unit is arranged to cover the sample cavity 802. As the blister unit is actuated a saliva from the mouth is sucked via the sample feeding inlet to the sample cavity 802 via a sample channel (also designated as Ch1+Ch2 in the figure @).

The sample is further moved from the sample cavity 802 to a first cavity 804 via a first channel 806 (also designated as Ch3+Ch4 in the FIG. 1). The first cavity 804 comprises a filter, thus the first cavity could be also considered or referred as filtering cavity in given embodiment. Pressure is applied to the first cavity to force the sample thru the filter and to move it via a third channel 814 to an expansion cavity 816. Expansion cavity 816 is connected fluidly (via a second channel 810) further to an overflow cavity 808. The first cavity 804 is connected to the overflow cavity 808 (via the expansion cavity 816) and the second channel 810.

Excess amount of sample flows via the second channel 810 to the overflow cavity 808. The overflow cavity 808 also receives possible excess fluids from sensor volume 825. The overflow cavity 808 is a channel having permeable bottom part which sucks fluids running in the second channel 810 on the area indicated in the FIG. 8.

The expansion cavity 816 is fluidically connected to a second cavity 812 via a fifth channel 818. The second cavity 812 contains antibodies. The second cavity 812 is connected to the first cavity via (the expansion cavity+fifth channel) and the third channel 814. Optionally a mixer structure mixer1 is part of the fifth channel 818. The mixer forms turbulence on the fluid comprising sample and antibodies thus mixing it better. Pistons are arranged to apply force sequentially to the expansion cavity 816 and to a third cavity 820 to move fluid back and forth via the second cavity 812. This way antibodies can be mixed in efficient way to the sample. The second cavity 812 is connected to the third cavity 820 by a fourth channel 822. The fourth channel 822 comprises optional mixer structure mixer2 to form turbulence on the fluid to further mix the sample with antibodies. Force is applied to the expansion cavity and the third cavity with a set of programmable pistons which are pressing on flexible membrane arranged on top of each cavity.

An exit aperture 824 is fluidically connected to the third cavity 820 via a sixth channel 826. The exit aperture 824 is in practice an outlet (or fluid collection area/volume/aperture) from the sixth channel 826 (as well as set of channels connecting cavities containing reagents or enzymes) to the sensor volume 825. The cavity plate 800 further comprises a first set of cavities 828A, 828B, 828C containing reagents or enzyme substrates. The first set of cavities are fluidly connected to the exit aperture 824 (or to their respective exit aperture) to provide fluids to the sensor volume 825 on the sensor layer. Reagents, enzymes, etc. are moved from respective cavity via respective channels to the sensor volume 825 depending on the phase of using analyzer and from the sensor volume 825 to the overflow cavity 808. In one example washer substance is forced from respective cavity to the sensor volume.

The sensor volume 825 is a volume to which fluids (being it sample mixed with antibodies or fluids from the first set of cavities) are provided via the exist aperture (or respective apertures). A sensor is arranged to measure properties of the fluids (and particularly the sample) in the volume when the sensor disc assembly is in use (i.e. used in analyzer).

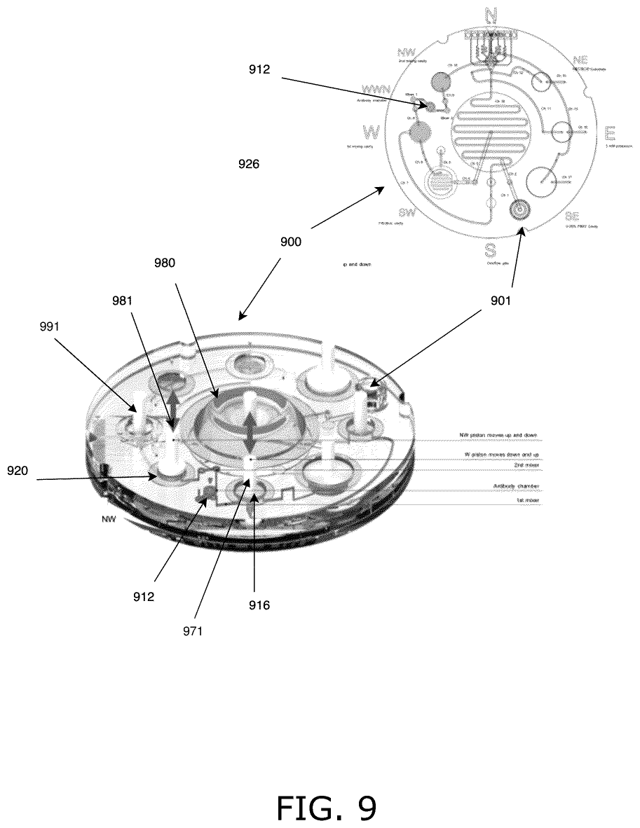

FIG. 9. is a high-level illustration of a sensor disc 900 as seen from top and in 3D. Relative position of the different cavities are indicated with directions N, NE, E, SE, S, SW, W, WWN, NW. In this example the sample feeding inlet 901 is between south(S) and southeast (SE) as indicated. A second cavity 912 is on direction WWN. A blister 980 is illustrated. The blister 980 is used, during a sample sequence, to pump sample from the sample feeding inlet 901 via a sample channel. When in use set of pistons are used to provide force to a cavity (thus emptying the cavity) by pressing membrane in top of the cavity and causing fluids in respective cavity to move out from the cavity and the cavity to “suck” fluids when the piston is extracted. When a piston is pressed down the cavity typically empties and blocks fluid flow from input channel of the cavity to output channel of the cavity.

Mixing sequency (mixing sample with antibodies) of the sensor disc comprises applying a force to the expansion cavity 916 (at direction W) with a piston 971 causing the sample to move via a fifth channel to a second cavity 912 (at direction WWN). Antibodies are accommodated in the second cavity 912. The sample mixes with the antibodies as the sample enters the second cavity. The sample (with antibodies) further moves towards the third cavity 920 (at direction NW). A piston of third cavity 981 is pressed down after this and the sample is moved back to the expansion cavity via the second cavity. This back-and-forth movement is repeated several times (such as 2, 3, 5, 10) to ensure that the sample is mixed with the antibodies. This sequential way ensures that antibodies, even in dried format on walls of the second cavity are mixed adequately with the sample.

As a last step of the mixing the sample mixed with the antibodies is moved to the third cavity, meaning that the piston 971 over the expansion cavity is down and the piston 981 over the third cavity is up.

The mixed sample is moved to the sensor volume on the sensor disc for analysis by moving a piston 991 over the sample volume (at direction N) up and moving the piston 981 over the third cavity down.

As a summary example embodiment of operation of the setup. The sensor disc assembly and the analyzer operate in a predefined sample handling sequence initiated by introducing a sample fluid, such as saliva, into the sensor disc assembly through a central blister mechanism. When actuated, the blister creates a negative pressure that draws the sample fluid through a sample feeding inlet into a designated filtration cavity. This filtration cavity is equipped with a stacked filter configuration comprising a first membrane for coarse particle removal and a second membrane for fine filtration. Prior to the filtration step, pistons associated with the cavity plate sequentially close downstream fluidic channels, ensuring unidirectional flow and fluidic isolation during pressurization. The sample fluid is then pressed through the filter stack into a first mixing cavity.

Following filtration, the sample fluid is conveyed into a second mixing cavity via a fluidic path that includes two integrated microfluidic mixers and an antibody cavity. The antibody cavity contains analyte-specific antibodies in solid or liquid form. Actuators coordinated by the analyzer generate a reciprocating flow between the first and second mixing cavities through the antibody chamber. This is achieved by alternating the positions of pistons acting on the respective cavities, thereby inducing turbulent flow through the mixers and ensuring uniform distribution and solubilization of the antibodies into the sample fluid.

Once a predetermined degree of mixing is reached, the fluid mixture is transferred into a third cavity positioned adjacent to a fluidic outlet leading to a volume in the sensor layer. Upon actuation of the associated piston, the mixture is pushed through this outlet, known as the north gate, into the sensor chamber. The sensor chamber is dimensioned to receive a controlled fluid volume and is equipped with electrodes or sensing surfaces for detecting specific analytes in the mixture.

Subsequent to sample introduction into the sensor volume, the analyzer executes a series of reagent handling steps. A buffer solution, such as 0.05% PBST, is delivered from a reagent cavity via a piston-controlled channel (SE piston up, through Ch 13 buffer moves to sample and then SE piston down), flushing the sensor chamber to remove unbound substances into the overflow cavity 808. A vane air pump then generates a pressurized air stream directed through a separate channel (Ch 14), expelling excess liquid from the sensor volume into an absorbent membrane via a dedicated outlet (e.g. drying). Following drying, additional reagents—including a chromogenic or electrochemical substrate—are delivered from their respective reagent cavities with flushing and drying steps in between the addition of each additional reagent. These steps are repeated as required to prepare the sensor for final measurement and signal acquisition.

This fluid handling sequence, orchestrated through coordinated piston movements and channel design, enables precise filtration, mixing, incubation, washing, and detection. The dynamic modulation of piston speeds, combined with microfluidic geometries, ensures that assay conditions are maintained with high repeatability and analytical fidelity.

1. A sensor disc assembly comprising:
a cavity plate comprising:
a sample cavity for receiving a sample collecting part containing a sample fluid or the sample fluid;
a first cavity fluidically connected to the sample cavity by a first channel;
an overflow cavity fluidically connected to the first cavity by a second channel;
a second cavity containing antibodies and fluidically connected to the first cavity by a third channel;
an expansion cavity fluidically connected to the second cavity by a fifth channel;
a third cavity for accommodating the sample fluid mixed with antibodies and connected to the second cavity by a fourth channel;
an exit aperture fluidically connected to the third cavity by a sixth channel; and
a first set of cavities containing reagents or enzyme substrates and fluidically connected to the exit aperture by respective first set of channels; and
a sensor layer comprising
a volume, wherein the fluids are provided to the volume from the exit aperture; and
a sensor arranged to measure properties of fluids in the volume, when in use.

2. The sensor disc assembly according to claim 1, wherein the cavity plate further comprises a flexible membrane covering at least partly the cavity plate or a set of flexible membranes covering respective cavities.

3. The sensor disc assembly according to claim 2, wherein the flexible membrane or at least some of flexible membranes of the set of flexible membranes is removably attached to the cavity plate.

4. The sensor disc assembly according of claim 1, wherein the sample cavity comprises a filter to filter the sample fluid prior to providing the sample fluid to the first cavity, wherein the filter is selected from a group of a fiber filter, a fiberglass filter, a natural porous material, a natural fiber material, a synthetic porous material or a synthetic fiber material.

5. The sensor disc assembly according of claim 1, wherein the expansion cavity comprises a spring-loaded piston to provide a first force to decrease a volume of the expansion cavity after expansion.

6. The sensor disc assembly according to claim 1, wherein the third channel is a branch channel of the fourth channel and the fluidic connection between the first cavity and the second cavity is via the third channel and the fourth channel.

7. The sensor disc assembly according to claim 1, wherein at least one of the first set of channels comprises a hydrophobic chamber.

8. The sensor disc assembly according to claim 1, wherein the antibodies in the second cavity are in one of: liquid form, or solid form.

9. An analyzer comprising:
a slot for receiving a sensor disc assembly, the sensor disc assembly having a cavity plate and a sensor layer;
a set of actuators arranged on the analyzer, when in use, to exert force to cavities of the cavity plate of the sensor disc assembly in a sequential manner to move fluids between the cavities by channels fluidically connecting the cavities;
an electrical interface to a sensor of the sensor layer; and
an interface to provide analysis results related to the sensor reading.

10. The analyzer according to claim 9, wherein the sensor disc assembly.

11. The analyzer according to claim 9, wherein the sequential manner comprises steps of:
a sample sequence to extract a sample fluid from a sample collecting part or to extract the sample fluid provided to a sample feeding inlet;
a mixing sequence to mix the extracted sample fluid with antibodies of a second cavity; and
a sensor fill sequence to move the sample fluid mixed with antibodies and reagents and/or enzymes to a volume of the sensor layer.

12. The analyzer according to claim 11, wherein the analyzer is configured to provide an electrical signal via the electrical interface to analyze fluids in the volume after the sensor fill sequence.

13. The analyzer according to claim 11, wherein the sample sequence comprises
(i) exerting a force with a third actuator to a third cavity of the cavity plate, to block a fluidic route from the third cavity to a sixth channel;
(ii) exerting a force to a sample cavity of the cavity plate with a sample press actuator, to extract the sample fluid from the sample collecting part, and to move the sample fluid to a first cavity of the cavity plate by a first channel, the first cavity being fluidically connected to an overflow cavity of the cavity plate by a second channel; and
(iii) exerting a force to an overflow actuator from amongst the set of actuators, to block the fluidic route via the second channel to the overflow cavity.

14. The analyzer according to claim 11, wherein the sample sequence comprises
(I) exerting a force to a blister unit arranged to cover the sample cavity to pump sample from a sample inlet and to move the sample to the first cavity for filtering and
(II) exerting a force to the first cavity to push the sample thru a filter housed in the first cavity via a third channel to an expansion cavity.

15. The analyzer according to claim 11, wherein the mixing sequence comprises, to mix the sample fluid with antibodies:
(iv) exerting a force with a first actuator from amongst the set of actuators to the first cavity to move the sample fluid via a third channel to a second cavity of the cavity plate, and from the second cavity further, via a fifth channel to an expansion cavity of the cavity plate;
(v) removing the force exerted by the first actuator to the first cavity to move the sample fluid from the expansion cavity via the fifth channel to the second cavity and from the second cavity further to the first cavity; and
optionally repeating (iv) and (v) a plurality of times to ensure that the sample fluid is mixed with the antibodies at least by a predetermined degree.

16. The analyzer according to claim 11, wherein the mixing sequency comprises:
(III) exerting a force to the expansion cavity to move the sample from the expansion cavity via a fifth channel to a second cavity accommodating antibodies and further to a third cavity
(VI) exerting a force to the third cavity to move the sample from the third cavity back to the expansion cavity via the second cavity
and
(V) repeating steps III and VI a plurality of times.

17. The analyzer according to claim 11, wherein the sensor fill sequence comprises:
(vi) removing the force exerted by the third actuator to open the fluidic route from the third cavity to the sixth channel; and
(vii) exerting a force with the first actuator to the first cavity to move the sample fluid antibody mixture via the third channel to the third cavity and from the third cavity further, via a sixth channel to the volume of the sensor.

18. The analyzer according to any of the claim 17, wherein the sensor fill sequence comprises:
(viii) exerting a force with the first actuator to the first cavity to move the sample fluid via the third channel to the second cavity and from the second cavity further, via the fifth channel to the expansion cavity; and
(ix) removing the force exerted by the third actuator to open the fluidic route from the third cavity to the sixth channel to move the sample fluid from the expansion cavity via the fifth channel to the second cavity and from the second cavity further to the third cavity and from the third cavity further, via the sixth channel to the volume of the sensor.

19. The analyzer according to claim 11, wherein the expansion cavity moves the sample fluid away from the expansion cavity by means of at least one of: a piston, a flexible member, an expansion cavity actuator.

20. The analyzer according to claim 11, wherein the sensor fill sequence further comprises
(x) extracting a force with at least one actuator associated with a first set of cavities, of the cavity plate, containing reagents or enzyme substrates to move respective reagents and/or enzymes to the volume of the sensor layer by respective first set of channels.

21. The analyzer according to claim 11, wherein the analyzer is configured to use the electrical interface of the sensor to analyze the sample fluid of the sensor layer and provide the analysis results related to the sensor reading.

22. The analyzer according to claim 11, wherein the actuators are selected from a set of: electrical actuators and manual actuator.
